(19) United States
(12) Patent Application Publication
(10) Pub. No.: US 2021/0146312 A1
(43) Pub. Date: May 20, 2021

(54) PROCESS FOR CLEANING A MEMBRANE COMPRISING DRYING THE MEMBRANE

(71) Applicant: DUPONT SAFETY & CONSTRUCTION, INC., Wilmington, DE (US)

(72) Inventors: Martin HEIJNEN, Greifenberg (DE); Michaela KRUG, Landsberg (DE); Cornelia WERZINGER, Greifenberg (DE)

(21) Appl. No.: 16/633,842

(22) PCT Filed: Jul. 24, 2018
(86) PCT No.: PCT/EP2018/070047

§ 371 Date: Jan. 24, 2020

(30) Foreign Application Priority Data
Aug. 3, 2017 (EP) 17184730.4

(51) Int. Cl. B01D 65/02; B01D 71/68; C02F 1/44; B08B 3/08

(52) U.S. Cl. CPC B01D 65/025; B01D 71/68; C02F 1/44; B08B 3/08; B01D 2321/18; B01D 2321/02; B01D 2321/164; B01D 2321/26; B01D 2321/162; C02F 2303/16; B01D 2321/32

(57) ABSTRACT

The invention relates to a process for cleaning a polymer membrane comprising the steps of (A) filtering an aqueous liquid through the polymer membrane; (B) drying the polymer membrane; (C) washing the polymer membrane with water or a chemical washing solution; and (D) continuing the filtering of the aqueous liquid through the polymer membrane.

The invention relates to a process for cleaning a polymer membrane comprising the steps of (A) filtering an aqueous liquid through the polymer membrane; (B) drying the polymer membrane; (C) washing the polymer membrane with water or a chemical washing solution; and (D) continuing the filtering of the aqueous liquid through the polymer membrane.

Membrane fouling is a very complex process, which is not yet fully understood. Most of the deposits consist of material not belonging to one single chemical “class” but, depending on the feed water conditions such as temperature, time of the year or intensity of rainfall, showing strong variations of its composition. For example, such fouling deposit may contain major components of:
Mechanical particles such as sand, clay, Si-compounds etc.
Scaling products from Ca—, Mg—, Ba— sulfate or carbonate
Iron precipitations
Bacteria and bacteria films
Algae and its biofilms
Polysaccharides, humic acids and other organics
Metabolism products from bacteria, algae and other microorganisms

In filtration processes, especially on industrial scale, the prevention of irreversible fouling and the maintenance of flux properties is most important. For the regular cleaning of filter units, such membranes thus are often contacted with for example oxidizing solutions; such steps are also recalled as chemical backwash, disinfection or bleaching. However, the known cleaning processes for membranes often do not lead to complete restoration of the permeability.

WO2014/170391 discloses the use of special polyurethane additives for the stabilization of a polymer membrane against the detrimental effects of acids, bases or oxidizing agents during cleaning.

WO2017/146196 discloses a specific filtration system which allow for chemical rinsing with an improved effictivity.

WO2013/164492 discloses the use of an alkoxylated surfactant for improved cleaning of polymer membranes.

Object of the present invention was to identify a process for cleaning a polymer membrane which can restore a high permeability of the membrane, which avoids the development of new cleaning agents and works with the established cleaning agents, which is environmentally friendly or cost efficient, or which works on the available filtration systems.

The object was solved by a process for cleaning a polymer membrane comprising the steps of
(A) filtering an aqueous liquid through the polymer membrane;
(B) drying the polymer membrane;
(C) washing the membrane with water or a chemical washing solution; and
(D) continuing the filtering of the aqueous liquid through the polymer membrane.

Typical filtration processes are operated at a constant flux rate. When fouling of the polymer membrane occurs the membrane resistance may increase and result in an increased transmembrane pressure (TMP). Usually, the fouling of the polymer membrane results in a reduced permeability. The permeability may be calculated by flux rate (given e.g. in the unit liter/(m²×h)) divided by transmembrane pressure (given e.g. in the unit bar).

The cleaning of a polymer membrane typically means that foulants are removed from the polymer membrane. The cleaning of a polymer membrane should increase its permability.

The process for cleaning according to the invention is often initiated when the permeability of the polymer membrane is below 50%, preferably below 35%, and in particular below 20% of the initial permeability of the clean membrane. In another form the process for cleaning may be initiated after a preset duration of time (e.g. in the range from 4 times per day to once per months), which usually depends on the membrane type and process conditions.

Step (A)

In step (A) an aqueous liquid is filtered through the polymer membrane. The filtration may be made by conventional filtration processes and parameters, which are known to experts.

The liquid may contain at least 80 wt %, preferably at least 90 wt %, and in particular at least 95 wt % water.

Usually, the liquid is industrial waste water, sea water, surface water, ground water, process water, drinking water, liquid food (e.g. a beverage, such as beer, wine, juices, dairy products, or soft drinks).

In one form the liquid is sea water. In another form the liquid is ground water or surface water. In another form the liquid is industrial waste water or process water. In another form the liquid is a beverage, such as beer.

Step (B)

In step (B) the the polymer membrane is dried, which may mean that is partially dried or fully dried.

The foulants usually are found on the filtration side surface and optionally partly in the inner region of the polymer membrane.

The term “drying the polymer membrane” may include
drying the foulants on the filtration side surface of the polymer membrane;
drying the foulants on the filtration side surface of the polymer membrane, and the filtration side surface of the polymer membrane;
drying the foulants on the filtration side surface of the polymer membrane, the filtration side surface of the polymer membrane, and the inner regions of the polymer membrane; or
drying the foulants on the filtration side surface of the polymer membrane, the filtration side surface of the polymer membrane, the inner regions of the polymer membrane, and the other regions of the polymer membrane (e.g. the permeate side surface of the polymer membrane).

In a preferred form step (B) is the drying the foulants on the filtration side surface of the polymer membrane.

In another preferred form step (B) is drying the foulants on the filtration side surface of the polymer membrane, and the filtration side surface of the polymer membrane.

In another preferred form step (B) is drying the foulants on the filtration side surface of the polymer membrane, the filtration side surface of the polymer membrane, and the inner regions of the polymer membrane.

In step (B) regarding the drying of the polymer membrane the amount of liquid in the polymer membrane may be reduced at least 0.1 wt %, preferably at least 3 wt %, and at least 10 wt % during the drying. In another form of step (B) the amount of liquid in the polymer membrane may be reduced at least 3 wt %, preferably at least 10 wt %, and at least 40 wt % during the drying.

In one form the amount of liquid is reduced during the drying at least 0.1 wt %, 0.5 wt %, 1 wt %, 2 wt %, 3 wt %, 5 wt %, 8 wt %, 12 wt %, 15 wt %, 17 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, or 99 wt %.

In another form the amount of liquid is reduced during the drying up to 10 wt %, 20 wt %, 30 wt %, 40 wt %, 50 wt %, 60 wt %, 70 wt %, 80 wt %, 90 wt %, or 100 wt %.

The amount of liquid which is reduced during the drying may be determined by the difference of weight of the polymer membrane including foulants on or in the membrane before and at the end of the drying.

Typically, the weight of the polymer membrane including foulants is determined before the drying (Start Weight), at the end of the drying step (B) (End Weight), and after removing all liquid from the polymer membrane, e.g. by completely drying in a hot vacuum (Fully Dried Weight). Thus, the percentage of the amount of liquid which is reduced during the drying can be calculated.

The drying may be achieved at any temperature. Typically, the drying is made at a temperature in the range from 0 to 100° C., preferably from 5 to 98° C., and in particular from 10 to 95° C.

The drying may be achieved at any time period. Typically, the drying may be achieved within 1 min to 48 h, preferably 5 min to 24 h, and in particular 30 min to 12 h.

In another form the drying is achieved in less than 7, 6, 5, 4, 3, or 2 days. In another form the drying is achieved in less than 48, 36, 24, 12, 6, 3, 2, or 1 hour. In another form the drying is achieved in less than 45, 30, 15, 5, 3, or 1 minute. In another form the drying is achieved more than 1, 15, 30, 45, or 60 seconds.

The drying may be achieved by applying a gas. Any gas is suitable in principle. Examples are air, CO₂, O₂, or N₂. In one form the drying is achieved by applying air. In another form the drying is achieved by applying CO₂. In another form the drying is achieved by applying O₂. In another form the drying is achieved by applying N₂.

The gas may be applied for 1 min to 48 h, preferably 1 h to 36 h, and in particular 6 h to 24 h.

The gas may be selected based on the liquid. Some liquids, such as beverages, may be affected negatively by the gas. Preferably, the gas is inert to the liquid. Preferably, when the liquid is a beverage, such as beer, then oxygen free gas is applied, such as CO₂ or N₂. In a preferred form the liquid is beer and the gas is CO₂.

Typically the application of the gas is made by blowing the gas on or through the polymer membrane.

Typically, the gas is applied to the filtration side of the membrane, which usually means the side where the retentate is.

The drying may be achieved by applying vacuum to the polymer membrane, preferably to the filtration side of the polymer membrane. The vacuum may have a pressure of below 800 mbar, 600 mbar, 400 mbar, 200 mbar, 50 mbar, 20 mbar, 5 mbar, or 1 mbar.

The vacuum may be applied for 1 min to 48 h, preferably 1 h to 36 h, and in particular 6 h to 24 h.

Step (C)

In step (C) the polymer membrane is washed with water or a chemical washing solution.

The washing of the polymer membrane with water is usually performed as back washing (BW). The water may be permeate, fresh water, feed water or any other clean water source.

In a typical back wash operation,
a first rinsing (e.g. by opening the retentate path during the active feed flow) step is performed for a short period of time (e.g. 10 to 60 seconds);
the flow rate of permeate during the back wash is much higher as the filtration rate. For dead end filtration it should be higher than the feedflow in filtration, typically more than 80 l/m²*h (higher flow rate is advantageous, but the mechanical membrane stability and the system costs have to be considered);
the amount of back wash per m² is preferably at least 1 l/m² per BW. The optimum typically depends on the feed water/wastewater quality, and is a compromise between the optimal membrane regeneration and the highest possible permeate yield.

To complete the back wash, higher pressure in permeate than in the feed should to be established in order to induce a high flow rate in reverse direction. Typically during BW, the feed inlet is closed and the retentate outlet is opened; a permeate buffer tank is advantageous.

The washing of the polymer membrane with a chemical washing solution is usually performed as chemically enhanced backwash (CEB) (also called sometimes a maintenance clean, or enhanced flux maintenance).

Usually, the chemical washing solution is an aqueous solution comprising an acid, a base, and/or an oxidant. Preferably, the chemical washing solution comprising an alkaline hydroxide, alkaline earth hydroxide, mineral acid, H₂O₂, ozone, peracid, ClO₂, KMnO₄, chlorate perchlorate or hypochlorite.

Often used chemical washing solutions are:
Sulfuric acid, typically in a concentration of 0.015 N or higher, so that the pH of the cleaning liquid ranges between 0.5 and 2.5.
Other inorganic acid solutions, typically of similar pH range.
Base solution, mostly NaOH as the cheapest base, typically in a concentration of 0.03 N or higher, so that the pH of cleaning solution ranges between 10.5 and 12.5.
Oxidizing agents such as NaOCl, typically in a concentration between 3 and 50 ppm in alkaline solution. Other oxidizing chemicals such as H₂O₂ can also be used.

In order to contact the membranes with the chemical washing solution, a separate chemical back wash system is usually applied, especially to avoid permeate contamination and/or to allow separate cleaning of different membrane sections. It may contain:
Dosing equipment of concentrated chemicals to the back wash permeate, such as dosing pumps, flow meters, pressure transmitters
Mixing device like for instance Venturi injector, pump injector or static mixer
pH sensor in feed for pH control of cleaning solution
pH sensor in outlet to ensure the complete removal of chemicals from the system
Separate piping system for removal of one chemical before the second one is applied.

In case of CEB, flow through the membrane is not as essential as in case of BW. The main point is that the CEB solution completely fills the modules to ensure optimal conditions for CEB in the whole membrane area.

In a typical CEB cleaning step, once one of the cleaning chemicals is filled into the module, the dosing is stopped and the static washing is started. The optimal washing time depends on the origin and composition of the deposits and the chemicals used, and often varies from about 5 to 60 minutes.

For example, a CEB sequence for optimal membrane regeneration may be as follows:
a) Rinsing of the modules using feed by opened retentate path (10-30 seconds);
b) NaOH washing, typically by filling NaOH solution into the module and steeping it for about 30-60 minutes;
c) ejection of NaOH solution, controlled, for instance, by a pH sensor;
d) NaOCl washing (or washing with any other oxidizing agent), e.g. by filling NaOCl solution into the module and steeping it for about 30-60 minutes (as an alternative, this step d may be combined with aforesaid step b);
e) ejection of NaOCl solution (or solution of the oxidizing agent), controlled, for instance, by a pH or redox sensor (alternatively to be combined with step c);
f) washing with acid, typically sulphuric acid, e.g. by filling H₂SO₄ solution into the module and steeping it for about 30-60 minutes;
g) ejection of acid solution, controlled, for instance, by a pH sensor;
h) restart of the permeate production procedure.

CEB is advantageously started, when the TMP increases above a certain value, or after a predefined operation time, for instance every 8 hrs.

Step© can also be performed by a CIP (Clean in Place) type of cleaning. In this case the cleaning agent (which can also include chelating agents, surfactants or enzymatic cleaners) may be recirculated over the filtration side of the membranes. Filtrate can be drawn off during part of this procedure.

Step (D)

In step (D) the filtering of the aqueous liquid through the polymer membrane is continued. The aqueous liquid may be the same as used in step (A) or it may be a different aqueous liquid. The filtering may be continued immediately after the end of step (C), or the polymer membrane may be stored for any desired time until filtration of the step (D) is continued.

The polymer membrane may be understood to be a thin, semipermeable structure capable of separating two fluids or separating molecular and/or ionic components or particles from a liquid. The membrane acts usually as a selective barrier, allowing some particles, substances or chemicals to pass through, while retaining others.

For example, the polymer membranes can be reverse osmosis (RO) membranes, forward osmosis (FO) membranes, nanofiltration (NF) membranes, ultrafiltration (UF) membranes or microfiltration (MF) membranes. These membrane types are generally known in the art and are further described below.

FO membranes are normally suitable for treatment of seawater, brackish water, sewage or sludge streams. Thereby pure water is removed from those streams through a FO membrane into a so called draw solution on the back side of the membrane having a high osmotic pressure. In a preferred embodiment, suitable FO membranes are thin film composite (TFC) FO membranes. In a particularly preferred embodiment, suitable FO membranes comprise a fabric layer, a support layer, a separation layer and optionally a protective layer. Said protective layer can be considered an additional coating to smoothen and/or hydrophilize the surface. Said fabric layer can for example have a thickness of 10 to 500 μm. Said fabric layer can for example be a woven or nonwoven, for example a polyester nonwoven. Said support layer of a TFC FO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise as the main component a polysulfone, polyethersulfone, polyphenylenesulfone, polyvinylidenedifluoride, polyimide, polyimideurethane. In one embodiment, FO membranes comprise a support layer comprising as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone (PSU), polyphenylenesulfone (PPSU) or polyethersulfone (PESU), or mixtures thereof. Said separation layer of a FO membrane can for example have a thickness of 0.05 to 1 μm, preferably 0.1 to 0.5 μm, more preferably 0.15 to 0.3 μm. preferably, said separation layer can for example comprise polyamide or cellulose acetate as the main component. Optionally, TFC FO membranes can comprise a protective layer with a thickness of 30-500 preferable 100-300 nm. Said protective layer can for example comprise polyvinylalcohol (PVA) as the main component. In one embodiment, the protective layer comprises a halamine like chloramine. In one preferred embodiment, suitable membranes are TFC FO membranes comprising a support layer comprising at least one polysulfone, polyphenylenesulfone and/or polyethersulfone, a separation layer comprising polyamide as main component and optionally a protective layer comprising polyvinylalcohol as the main component. In a preferred embodiment suitable FO membranes comprise a separation layer obtained from the condensation of a polyamine and a polyfunctional acyl halide. Said separation layer can for example be obtained in an interfacial polymerization process.

RO membranes are normally suitable for removing molecules and ions, in particular monovalent ions. Typically, RO membranes are separating mixtures based on a solution/diffusion mechanism. In a preferred embodiment, suitable membranes are thin film composite (TFC) RO membranes. In a further preferred embodiment, suitable RO membranes comprise a fabric layer, a support layer, a separation layer and optionally a protective layer. Said protective layer can be considered an additional coating to smoothen and/or hydrophilize the surface. Said fabric layer can for example have a thickness of 10 to 500 μm. Said fabric layer can for example be a woven or nonwoven, for example a polyester nonwoven. Said support layer of a TFC RO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise as the main component a polysulfone, polyethersulfone, polyphenylenesulfone, PVDF, polyimide, polyimideurethane or cellulose acetate. In one embodiment, RO membranes comprise a support layer comprising as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone, or mixtures thereof. In another preferred embodiment, RO membranes comprise a support layer comprising as the main component at least one polysulfone, polyphenylenesulfone and/or polyethersulfone. Said separation layer can for example have a thickness of 0.02 to 1 μm, preferably 0.03 to 0.5 μm, more preferably 0.05 to 0.3 μm. Preferably said separation layer can for example comprise polyamide or cellulose acetate as the main component. Optionally, TFC RO membranes can comprise a protective layer with a thickness of 5 to 500 preferable 10 to 300 nm. Said protective layer can for example comprise polyvinylalcohol (PVA) as the main component. In one embodiment, the protective layer comprises a halamine like chloramine. In one preferred embodiment, suitable membranes are TFC RO membranes comprising a nonwoven polyester fabric, a support layer comprising at least one polysulfone, polyphenylenesulfone and/or polyethersulfone, a separation layer comprising polyamide as main component and optionally a protective layer comprising polyvinylalcohol as the main component. In a preferred embodiment suitable RO membranes comprise a separation layer obtained from the condensation of a polyamine and a polyfunctional acyl halide. Said separation layer can for example be obtained in an interfacial polymerization process. Suitable polyamine monomers can have primary or secondary amino groups and can be aromatic (e. g. a diaminobenzene, a triaminobenzene, m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e. g. ethylenediamine, propylenediamine, piperazine, and tris(2-diaminoethyl)amine). Suitable polyfunctional acyl halides include trimesoyl chloride (TMC), trimellitic acid chloride, isophthaloyl chloride, terephthaloyl chloride and similar compounds or blends of suitable acyl halides. As a further example, the second monomer can be a phthaloyl halide. In one embodiment of the invention, a separation layer of polyamide is made from the reaction of an aqueous solution of meta-phenylene diamine MPD with a solution of trimesoyl chloride (TMC) in an apolar solvent.

NF membranes are normally especially suitable for removing multivalent ions and large monovalent ions. Typically, NF membranes function through a solution/diffusion or/and filtration-based mechanism. NF membranes are normally used in crossflow filtration processes. In one embodiment, NF membranes comprise as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone, or mixtures thereof. In another embodiment of the invention, NF membranes comprise as the main component at least one polysulfone, polyphenylenesulfone and/or polyethersulfone. In a particularly preferred embodiment, the main components of a NF membrane are positively or negatively charged. In another embodiment, NF membranes comprise as the main component polyamides, polyimides or polyimide urethanes, Polyetheretherketone (PEEK) or sulfonated polyetheretherketone (SPEEK).

UF membranes are normally suitable for removing suspended solid particles and solutes of high molecular weight, for example above 10000 Da. In particular, UF membranes are normally suitable for removing bacteria and viruses. UF membranes normally have an average pore diameter of 2 nm to 50 nm, preferably 5 to 40 nm, more preferably 5 to 20 nm. In one embodiment, UF membranes comprise as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone, or polyethersulfone, or mixtures thereof. In another embodiment of the invention, UF membranes comprise as the main component at least one polysulfone, polyphenylenesulfone and/or polyethersulfone. “Polysulfones”, “polyethersulfones” and “polyphenylenesulfones” shall include the respective polymers that comprise sulfonic acid and/or salts of sulfonic acid at some of the aromatic moieties. In one embodiment, UF membranes comprise as the main component or as an additive at least one partly sulfonated polysulfone, partly sulfonated polyphenylenesulfone and/or partly sulfonated polyethersulfone. In one embodiment, UF membranes comprise as the main component or as an additive at least one partly sulfonated polyphenylenesulfone. “Arylene ethers”, “Polysulfones”, “polyethersulfones” and “polyphenylenesulfones” shall include block polymers that comprise blocks of the respective arylene ethers, Polysulfones, polyethersulfones or polyphenylenesulfones as well as other polymer blocks. In one embodiment, UF membranes comprise further additives like polyvinyl pyrrolidones.

In one embodiment of the invention, UF membranes are present as spiral wound membranes, as pillows or flat sheet membranes. In another embodiment of the invention, UF membranes are present as tubular membranes. In another embodiment of the invention, UF membranes are present as hollow fiber membranes or capillaries. In yet another embodiment of the invention, UF membranes are present as single bore hollow fiber membranes. In yet another embodiment of the invention, UF membranes are present as multibore hollow fiber membranes.

Multiple channel membranes, also referred to as multibore membranes, comprise more than one longitudinal channels also referred to simply as “channels”. In a preferred embodiment, the number of channels is typically 2 to 19. In one embodiment, multiple channel membranes comprise two or three channels. In another embodiment, multiple channel membranes comprise 5 to 9 channels. In one preferred embodiment, multiple channel membranes comprise seven channels. In another embodiment the number of channels is 20 to 100. The shape of such channels, also referred to as “bores”, may vary. In one embodiment, such channels have an essentially circular diameter. In another embodiment, such channels have an essentially ellipsoid diameter. In yet another embodiment, channels have an essentially rectangular diameter. In some cases, the actual form of such channels may deviate from the idealized circular, ellipsoid or rectangular form. Normally, such channels have a diameter (for essentially circular diameters), smaller diameter (for essentially ellipsoid diameters) or smaller feed size (for essentially rectangular diameters) of 0.05 mm to 3 mm, preferably 0.5 to 2 mm, more preferably 0.9 to 1.5 mm. In another preferred embodiment, such channels have a diameter (for essentially circular diameters), smaller diameter (for essentially ellipsoid diameters) or smaller feed size (for essentially rectangular diameters) in the range from 0.2 to 0.9 mm. For channels with an essentially rectangular shape, these channels can be arranged in a row. For channels with an essentially circular shape, these channels are in a preferred embodiment arranged such that a central channel is surrounded by the other channels. In one preferred embodiment, a membrane comprises one central channel and for example four, six or 18 further channels arranged cyclically around the central channel. The wall thickness in such multiple channel membranes is normally from 0.02 to 1 mm at the thinnest position, preferably 30 to 500 μm, more preferably 100 to 300 μm. Normally, the membranes and carrier membranes have an essentially circular, ellipsoid or rectangular diameter. Preferably, membranes are essentially circular. In one preferred embodiment, membranes according to the invention have a diameter (for essentially circular diameters), smaller diameter (for essentially ellipsoid diameters) or smaller feed size (for essentially rectangular diameters) of 2 to 10 mm, preferably 3 to 8 mm, more preferably 4 to 6 mm. In another preferred embodiment, membranes have a diameter (for essentially circular diameters), smaller diameter (for essentially ellipsoid diameters) or smaller feed size (for essentially rectangular diameters) of 2 to 4 mm. In one embodiment the rejection layer is located on the inside of each channel of said multiple channel membrane. In one embodiment, the channels of a multibore membrane may incorporate an active layer with a pore size different to that of the carrier membrane or a coated layer forming the active layer. Suitable materials for the coated layer are polyoxazoline, polyethylene glycol, polystyrene, hydrogels, polyamide, zwitterionic block copolymers, such as sulfobetaine or carboxybetaine. The active layer can have a thickness in the range from 10 to 500 nm, preferably from 50 to 300 nm, more preferably from 70 to 200 nm. In one embodiment multibore membranes are designed with pore sizes between 0.2 and 0.01 μm. In such embodiments the inner diameter of the capillaries can lie between 0.1 and 8 mm, preferably between 0.5 and 4 mm and particularly preferably between 0.9 and 1.5 mm. The outer diameter of the multibore membrane can for example lie between 1 and 26 mm, preferred 2.3 and 14 mm and particularly preferred between 3.6 and 6 mm. Furthermore, the multibore membrane can contain 2 to 94, preferably 3 to 19 and particularly preferred between 3 and 14 channels. Often multibore membranes contain seven channels. The permeability range can for example lie between 100 and 10000 L/m² hbar, preferably between 300 and 2000 L/m²hbar.

MF membranes are normally suitable for removing particles with a particle size of 0.1 μm and above. MF membranes normally have an average pore diameter of 0.05 μm to 10 μm, preferably 1.0 μm to 5 μm. Microfiltration can use a pressurized system but it does not need to include pressure. MF membranes can be capillaries, hollow fibers, flat sheet, tubular, spiral wound, pillows, hollow fine fiber or track etched. They are porous and allow water, monovalent species (Na+, Cl—), dissolved organic matter, small colloids and viruses through but retain particles, sediment, algae or large bacteria. Microfiltration systems are designed to remove suspended solids down to 0.1 micrometers in size, in a feed solution with up to 2-3% in concentration. In one embodiment, MF membranes comprise as the main component at least polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone, or mixtures thereof. In another embodiment of the invention, MF membranes comprise as the main component or as an additive at least one polysulfone, polyphenylenesulfone and/or polyethersulfone. In one embodiment, MF membranes comprise as the main component or as an additive at least one partly sulfonated polysulfone, partly sulfonated polyphenylenesulfone and/or partly sulfonated polyethersulfone. In one embodiment, UF membranes comprise as the main component or as an additive at least one partly sulfonated polyphenylenesulfone.

The polymer membranes may be based on at least one polymer selected from polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone (PSU), polyphenylenesulfone (PPSU) or polyethersulfone (PESU), or mixtures thereof. Preferably, polymer is selected from poly(vinylidene fluoride) (PVDF), polyarylene ether, polysulfone (PSU), polyphenylenesulfone (PPSU) or polyethersulfone (PESU). In one especially preferred embodiment, polymer is polyethersulfone.

In another preferred for the polymer membrane is based on polyvinyl pyrolidone, polyvinyl acetates, polyurethanes, cellulose acetates, polyacrylonitriles, polyamides, polyolefines, polyesters, polysulfones, polyethersulfones, polycarbonates, polyether ketones, sulfonated polyether ketones, polyamide sulfones, polyvinylidene fluorides, polyvinylchlorides, polystyrenes and polytetrafluorethylenes, copolymers thereof, and mixtures thereof, which polymer or mixture thereof preferably makes up 80 percent or more of the membrane weight. In an especially preferred form the polymer membrane is based on polysulfones, polyethersulfones, copolymers thereof, and mixtures thereof, which polymer or mixture thereof preferably makes up 80 percent or more of the membrane weight.

### EXAMPLE 1

A commercially available membrane module, type dizzer® XL 60 from inge GmbH (Greifenberg, Germany), has been used for filtration of surface water. The module contained the polyether sulfone based Multibore® 0.9 membranes with 7 capillaries per fibre, 0.9 mm capillary inner diameter and a pore size of about 0.02 μm and the mode of operation was In-to-Out filtration. The module had a membrane area of 60 m², a length without end cap of 148.6 cm and an outer diameter of 25.0 cm.

After operating successfully for many months, some unidentified water constituent fouled the membrane significantly and the permeability was significantly reduced.

Comparative Cleaning Process:

The usual chemical cleanings, using NaOH (pH up to 13), NaOCl (up to 500 ppm) and H₂SO₄ (about pH 1) were not able to restore the permeability of the membrane to acceptable levels.

Inventive Cleaning Process:

The module was removed from the treatment plant and the three 2 inch module openings (feed top, feed bottom, permeate) were opened, so that the membranes partially dried at room temperature for about 48 h. Next, the membrane was chemically cleaned with an aqueous solution of NaOH (pH up to 13), NaOCl (up to 500 ppm) or H₂SO₄ (about pH 1). When the module was tested, it was found that the permeability had restored close to the levels of a new membrane and it could be used again for the filtration of surface water.

1: A process for cleaning a polymer membrane, comprising:
(A) filtering an aqueous liquid through the polymer membrane;
(B) drying the polymer membrane;
(C) washing the polymer membrane with water or a chemical washing solution; and
(D) continuing the filtering of the aqueous liquid through the polymer membrane.

2: The process according to claim 1, wherein an amount of liquid in the polymer membrane is reduced at least 3 wt %, during the drying (B).

3: The process according to claim 1, wherein the drying is made at a temperature in the range from 0 to 100° C.

4: The process according to claim 1, wherein the drying is achieved within 1 min to 48 h.

5: The process according to claim 1, wherein the drying is achieved by applying a gas.

6: The process according to claim 5, wherein the gas is applied to a filtration side of the membrane.

7: The process according to claim 5, wherein the gas is inert to the liquid.

8: The process according to claim 1, wherein the drying is achieved by applying vacuum to a filtration side of the membrane.

9: The process according to claim 1, wherein the liquid comprises at least 80 wt % water.

10: The process according to claim 1, wherein the liquid is industrial waste water, sea water, surface water, ground water, process water, drinking water, or liquid food.

11: The process according to claim 1, wherein the chemical washing solution is an aqueous solution comprising an acid, a base, and/or an oxidant.

12: The process according to claim 1, wherein the chemical washing solution comprises an alkaline hydroxide, alkaline earth hydroxide, mineral acid, H₂O₂, ozone, peracid, ClO₂, KMnO₄, chlorate perchlorate or hypochlorite.

13: The process according to claim 1, wherein the polymer membrane is based on polyvinyl pyrolidone, polyvinyl acetates, polyurethanes, cellulose acetates, polyacrylonitriles, polyamides, polyolefines, polyesters, polysulfones, polyethersulfones, polycarbonates, polyether ketones, sulfonated polyether ketones, polyamide sulfones, polyvinylidene fluorides, polyvinylchlorides, polystyrenes, polytetrafluorethylenes, copolymers thereof, and mixtures thereof.

14: The process according to claim 1, wherein the polymer membrane is based on polysulfones, polyethersulfones, copolymers thereof, and mixtures thereof.
